(19) United States
(12) Patent Application Publication
(10) Pub. No.: US 2025/0232699 A1
(43) Pub. Date: Jul. 17, 2025

(54) DISPLAY DEVICE PERFORMING IMAGE STICKING COMPENSATION, METHOD OF COMPENSATING FOR IMAGE STICKING IN A DISPLAY DEVICE, AND ELECTRONIC DEVICE INCLUDING THE DISPLAY DEVICE

(71) Applicant: Samsung Display Co., LTD., Yongin-si (KR)

(72) Inventors: JONGMAN KIM, Yongin-si (KR); KYOUNGHO LIM, Yongin-si (KR); SANGMYEON HAN, Yongin-si (KR); SEUNGHO PARK, Yongin-si (KR); BYOUNGKWAN AN, Yongin-si (KR)

(21) Appl. No.: 18/984,362

(22) Filed: Dec. 17, 2024

(30) Foreign Application Priority Data
Jan. 16, 2024 (KR) 10-2024-0006512

(51) Int. Cl. G09G 3/20

(52) U.S. Cl. CPC G09G 3/20; G09G 2320/0257; G09G 2340/0435

(57) ABSTRACT

A display device includes: a display panel; and a display panel driver to generate a data signal based on input image data, and generate a data voltage based on the data signal to provide the data voltage to the display panel. The display panel driver is further to: select compensation data from among first to K-th compensation data having different resolutions from each other, where K is a positive integer of 2 or more, the compensation data corresponding to an input resolution of the input image data; compensate for the input image data to generate the data signal by using the compensation data corresponding to the input resolution; accumulate the input image data to generate intermediate accumulated stress data; and change a resolution of the intermediate accumulated stress data to a reference resolution to generate accumulated stress data.

### CROSS-REFERENCE TO RELATED APPLICATION

The present application claims priority to and the benefit of Korean Patent Application No. 10-2024-0006512, filed on Jan. 16, 2024, in the Korean Intellectual Property Office (KIPO), the entire disclosure of which is incorporated by reference herein.

### BACKGROUND

### 1. Field

Aspects of embodiments of the present disclosure relate to a display device, a method of compensating for an image sticking in the display device, and an electronic device including the display device.

### 2. Description of the Related Art

In general, a display device includes a display panel and a display panel driver. The display panel includes gate lines, data lines, and pixels. The display panel driver includes a gate driver for providing gate signals to the gate lines, a data driver for providing data voltages to the data lines, and a driving controller for controlling the gate driver and the data driver. The display panel driver may further include a volatile memory and a nonvolatile memory.

The pixels may deteriorate over time. When the pixels deteriorate, an image sticking may be visible on the display panel. In order to prevent the image sticking from being visible, the driving controller may perform an image sticking compensation for each of the pixels. In order to compensate for the image sticking, the driving controller may accumulate input image data to generate accumulated stress data for each of the pixels, and may generate compensation data for each of the pixels based on the accumulated stress data for each of the pixels.

The above information disclosed in this Background section is for enhancement of understanding of the background of the present disclosure, and therefore, it may contain information that does not constitute prior art.

### SUMMARY

As a technology advances, a resolution of the display panel corresponding to a number of the pixels has been gradually increasing, and an input resolution, which is a resolution of the input image data, may be different from the resolution of the display panel. When the input resolution is different from the resolution of the display panel, the accumulated stress data may be generated based on the input resolution, and may not reflect the resolution of the display panel. Therefore, the accumulated stress data may not accurately reflect a deterioration degree of the pixels. In more detail, the accumulated stress data may not accurately reflect the deterioration degree of the pixels corresponding to a difference between the input resolution and the resolution of the display panel. Therefore, the image sticking compensation may not be accurately performed.

One or more embodiments of the present disclosure may be directed to a display device capable of accurately performing an image sticking compensation.

One or more embodiments of the present disclosure may be directed to a method of compensating for an image sticking in a display device to accurately perform an image sticking compensation.

One or more embodiments of the present disclosure may be directed to an electronic device including the display device.

According to one or more embodiments of the present disclosure, a display device includes: a display panel; and a display panel driver configured to generate a data signal based on input image data, and generate a data voltage based on the data signal to provide the data voltage to the display panel. The display panel driver is further configured to: select compensation data from among first to K-th compensation data having different resolutions from each other, where K is a positive integer of 2 or more, the compensation data corresponding to an input resolution of the input image data; compensate for the input image data to generate the data signal by using the compensation data corresponding to the input resolution; accumulate the input image data to generate intermediate accumulated stress data; and change a resolution of the intermediate accumulated stress data to a reference resolution to generate accumulated stress data.

In an embodiment, the reference resolution may be equal to a resolution of the display panel.

In an embodiment, a resolution of the data signal may be equal to the reference resolution.

In an embodiment, the resolution of the intermediate accumulated stress data may be equal to the input resolution.

In an embodiment, a resolution of the accumulated stress data may be equal to the reference resolution.

In an embodiment, when the input resolution is changed, the resolution of the data signal and the resolution of the accumulated stress data may be constant at the reference resolution, and the resolution of the intermediate accumulated stress data may be changed depending on the input resolution.

In an embodiment, the display panel driver may include: a nonvolatile memory configured to store the accumulated stress data and the first to K-th compensation data; a compensation data selector configured to select the compensation data corresponding to the input resolution from among the first to K-th compensation data; a compensator configured to compensate for the input image data to generate the data signal by using the compensation data corresponding to the input resolution; an accumulator configured to accumulate the input image data to generate the intermediate accumulated stress data; and an accumulated resolution converter configured to change the resolution of the intermediate accumulated stress data to the reference resolution to generate the accumulated stress data.

In an embodiment, the display panel driver may further include a compensation volatile memory configured to store the compensation data corresponding to the input resolution selected by the compensation data selector.

In an embodiment, the display panel driver may further include: a first accumulated volatile memory configured to store the accumulated stress data generated by the accumulated resolution converter; and a second accumulated volatile memory configured to store the accumulated stress data provided from the nonvolatile memory.

In an embodiment, the display panel driver may further include an intermediate compensation data generator configured to generate intermediate compensation data corresponding to the accumulated stress data based on the accumulated stress data stored in the nonvolatile memory.

In an embodiment, the display panel driver may further include a compensation resolution converter configured to change the resolution of the intermediate compensation data to the input resolution.

In an embodiment, the compensation data corresponding to the input resolution from among the first to K-th compensation data may be updated based on the change of the resolution of the intermediate compensation data.

According to one or more embodiments of the present disclosure, a method of compensating for an image sticking in a display device, includes: selecting compensation data from among first to K-th compensation data having different resolutions from each other, where K is a positive integer of 2 or more, the compensation data corresponding to an input resolution of input image data; compensating for the input image data to generate a data signal by using the compensation data corresponding to the input resolution; accumulating the input image data to generate intermediate accumulated stress data; and changing a resolution of the intermediate accumulated stress data to a reference resolution to generate accumulated stress data.

In an embodiment, the reference resolution may be equal to a resolution of a display panel.

In an embodiment, a resolution of the data signal may be equal to the reference resolution.

In an embodiment, the resolution of the intermediate accumulated stress data may be equal to the input resolution.

In an embodiment, a resolution of the accumulated stress data may be equal to the reference resolution.

In an embodiment, when the input resolution is changed, the resolution of the data signal and the resolution of the accumulated stress data may be constant at the reference resolution, and the resolution of the intermediate accumulated stress data may be changed depending on the input resolution.

In an embodiment, the method may further include: generating intermediate compensation data corresponding to the accumulated stress data based on the accumulated stress data.

In an embodiment, the method may further include: changing a resolution of the intermediate compensation data to the input resolution.

In an embodiment, the method may further include: updating the compensation data corresponding to the input resolution from among the first to K-th compensation data based on the changing of the resolution of the intermediate compensation data.

According to one or more embodiments of the present disclosure, a electronic device includes: a display panel; a display panel driver configured to generate a data signal based on input image data, and generate a data voltage based on the data signal to provide the data voltage to the display panel; and a processor configured to control the display panel driver. The display panel driver is further configured to: select compensation data from among first to K-th compensation data having different resolutions from each other, where K is a positive integer of 2 or more, the compensation data corresponding to an input resolution of the input image data; compensate for the input image data to generate the data signal by using the compensation data corresponding to the input resolution; accumulate the input image data to generate intermediate accumulated stress data; and change a resolution of the intermediate accumulated stress data to a reference resolution to generate accumulated stress data.

According to some embodiments of the present disclosure, from among the first to K-th compensation data having the different resolutions, the compensation data corresponding to the input resolution may be selected to compensate for the input image data. The resolution of the intermediate accumulated stress data generated by accumulating the input image data may be changed to the reference resolution to generate the accumulated stress data. Therefore, even when or if the input resolution is different from the reference resolution, the accumulated stress data may accurately reflect a deterioration degree of the pixels included in the display panel.

According to some embodiments of the present disclosure, the resolution of the accumulated stress data having the reference resolution may be changed to the input resolution to update the compensation data corresponding to the input resolution from among the first to K-th compensation data.

However, the aspects and features of the present disclosure are not limited to those described above. The above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a block diagram showing a display device according to one or more embodiments of the present disclosure;

FIG. 2 is a block diagram showing the display panel driver of FIG. 1;

FIGS. 3 and 4 are diagrams showing an example of an operation when the input resolution is equal to the reference resolution;

FIGS. 5 and 6 are diagrams showing an example of an operation when an input resolution is different from a reference resolution;

FIG. 7 is a flowchart illustrating a method of compensating for an image sticking in a display device according to one or more embodiments of the present disclosure;

FIG. 8 is a block diagram illustrating an electronic device; and

FIG. 9 is a diagram illustrating the electronic device of FIG. 8 in an embodiment implemented as a smart phone.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

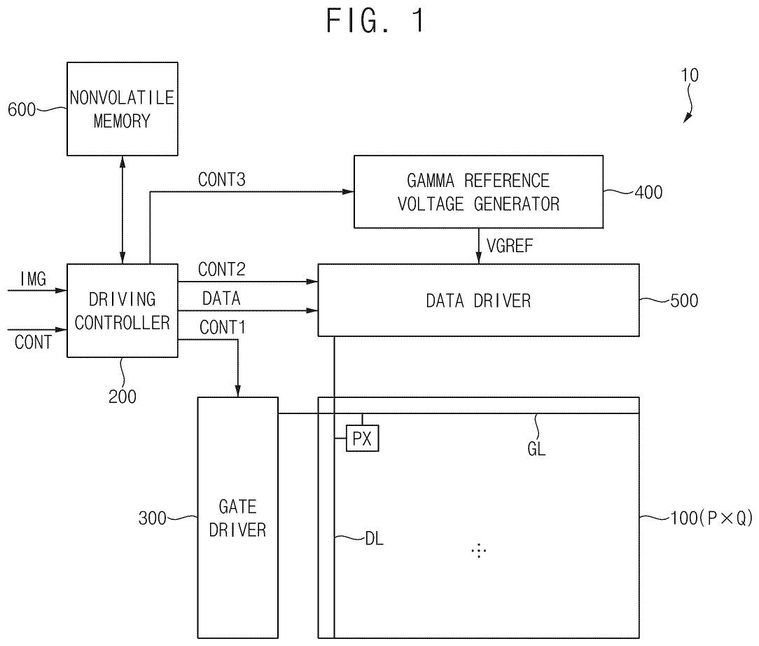

FIG. 1 is a block diagram showing a display device 10 according to one or more embodiments of the present disclosure.

Referring to FIG. 1, the display device 10 may include a display panel 100 and a display panel driver. The display panel driver may include a driving controller 200, a gate driver 300, a gamma reference voltage generator 400, and a data driver 500. The display panel driver may further include a nonvolatile memory 600.

The display panel 100 may include a display area for displaying an image, and a peripheral area disposed adjacent to the display area.

The display panel 100 may include gate lines GL, data lines DL, and pixels PX electrically connected to the gate lines GL and the data lines DL. The gate lines GL may extend in a first direction, and the data lines DL may extend in a second direction crossing the first direction. When a number of the pixels PX is P×Q (where P and Q are positive integers of 1 or more), the resolution of the display panel 100 including the pixels PX may be P×Q. For example, P×Q may be equal to 3840×2160 (UHD; Ultra High Definition). The resolution of the display panel 100 may be referred to as a reference resolution.

The driving controller 200 may receive input image data IMG and an input control signal CONT from an external device. For example, the input image data IMG may include red image data, green image data, and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The gate driver 300 may generate gate signals for driving the gate lines GL in response to the first control signal CONT1 received from the driving controller 200. The gate driver 300 may output the gate signals to the gate lines GL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

In an embodiment, the gamma reference voltage generator 400 may be disposed in the driving controller 200, or may be disposed in the data driver 500.

The data driver 500 may receive the second control signal CONT2 and the data signal DATA from the driving controller 200, and may receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

The nonvolatile memory 600 may store accumulated stress data, and compensation data corresponding to the accumulated stress data. The accumulated stress data may be generated by accumulating the input image data IMG, and the compensation data may be generated based on the accumulated stress data. Because the accumulated stress data indicates a deterioration degree of the pixels PX, the accumulated stress data may be stored in the nonvolatile memory 600, such that the accumulated stress data may not be erased even when the display device 10 is turned off. The compensation data may be data for compensating the input image data IMG. In an embodiment, the nonvolatile memory 600 may be implemented as a flash memory, but the present disclosure is not limited thereto.

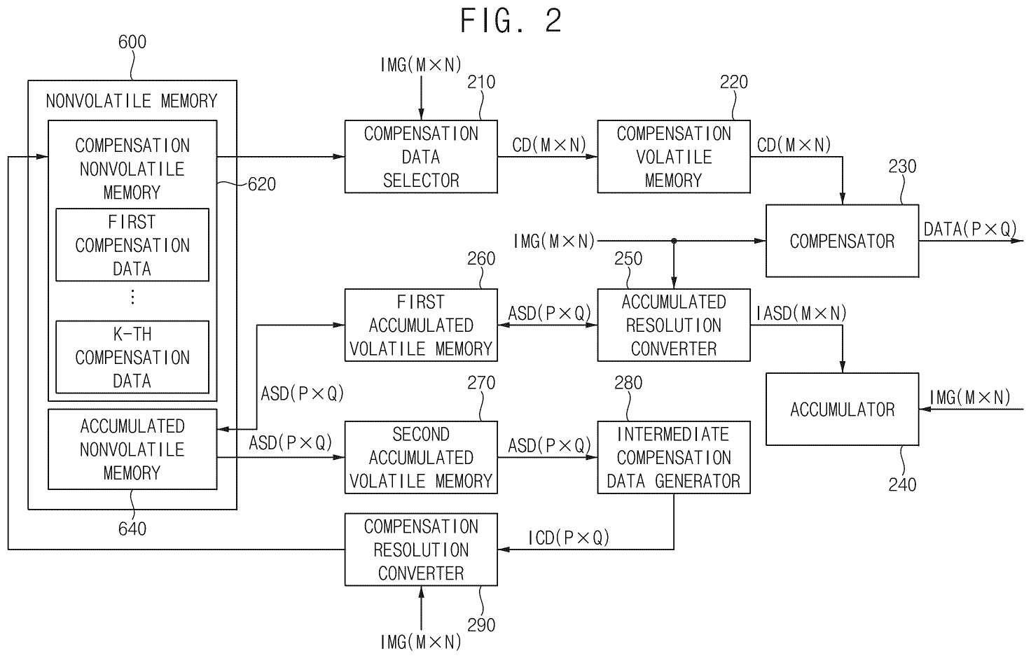

FIG. 2 is a block diagram showing the display panel driver of FIG. 1.

Referring to FIGS. 1 and 2, the display panel driver may include the nonvolatile memory 600 and the driving controller 200. The driving controller 200 may include a compensation data selector 210, a compensation volatile memory 220, a compensator 230, an accumulator 240, an accumulated resolution converter 250, a first accumulated volatile memory 260, a second accumulated volatile memory 270, an intermediate compensation data generator 280, and a compensation resolution converter 290.

The nonvolatile memory 600 may include a compensation nonvolatile memory 620 and an accumulated nonvolatile memory 640. The compensation nonvolatile memory 620 may store first to K-th compensation data. A resolution of each of the first to K-th compensation data may be different from the others. The accumulated nonvolatile memory 640 may store accumulated stress data ASD. The first to K-th compensation data may be generated based on the accumulated stress data ASD. The accumulated stress data ASD may be data that is accumulated for an image sticking compensation, and the first to K-th compensation data may be data for generating a compensation value used for the image sticking compensation according to an input resolution, which is a resolution of the input image data IMG. The input resolution may be M×N (where M and N are positive integers of 1 or more).

The compensation data selector 210 may receive the first to K-th compensation data from the compensation nonvolatile memory 620. In addition, the compensation data selector 210 may receive the input image data IMG. The compensation data selector 210 may select compensation data CD corresponding to the input resolution from among the first to K-th compensation data. Therefore, a resolution of the compensation data CD corresponding to the input resolution may be equal to or substantially equal to the input resolution, and a resolution of the compensation data CD corresponding to the input resolution may be M×N.

The compensation volatile memory 220 may receive the compensation data CD corresponding to the input resolution from the compensation data selector 210. The compensation volatile memory 220 may store the compensation data CD corresponding to the input resolution.

The compensator 230 may receive the compensation data CD corresponding to the input resolution from the compensation volatile memory 220. In addition, the compensator 230 may receive the input image data IMG. The compensator 230 may compensate for the input image data IMG using the compensation data CD corresponding to the input resolution to generate a data signal DATA. A resolution of the data signal DATA may be equal to or substantially equal to the reference resolution, regardless of the input resolution. Therefore, the resolution of the data signal DATA may be P×Q. In other words, the compensator 230 may compensate for the input image data IMG, such that the resolution of the data signal DATA may become (e.g., may become equal to or substantially equal to) the reference resolution, regardless of the input resolution. Because the pixels PX may be deteriorated based on the resolution of the data signal DATA, the pixels PX may be deteriorated based on the reference resolution, regardless of the input resolution.

The accumulator 240 may receive the input image data IMG. The accumulator 240 may accumulate the input image data IMG to generate intermediate accumulated stress data IASD. In more detail, for each frame, the accumulator 240 may accumulate the input image data IMG to the intermediate accumulated stress data IASD of a previous frame to generate the intermediate accumulated stress data IASD of a current frame. However, an update cycle of the intermediate accumulated stress data IASD is not limited to one frame. Therefore, a resolution of the intermediate accumulated stress data IASD may be equal to or substantially equal to the input resolution, and the resolution of the intermediate accumulated stress data IASD may be M×N. In other words, unlike the compensator 230, the accumulator 240 may generate the intermediate accumulated stress data IASD having the resolution that changes according to the input resolution. Therefore, when the resolution of the intermediate accumulated stress data IASD is different from the resolution of the data signal DATA, the intermediate accumulated stress data IASD may not accurately reflect a deterioration degree of the pixels PX.

The accumulated resolution converter 250 may receive the intermediate accumulated stress data IASD from the accumulator 240. In addition, the accumulated resolution converter 250 may receive the input image data IMG. The accumulated resolution converter 250 may change the resolution of the intermediate accumulated stress data IASD to the reference resolution to generate the accumulated stress data ASD. Therefore, the resolution of the accumulated stress data ASD may be P×Q. Accordingly, because the resolution of the accumulated stress data ASD is equal to or substantially equal to the resolution of the data signal DATA regardless of the input resolution, the accumulated stress data ASD may more accurately reflect the deterioration degree of the pixels PX.

The first accumulated volatile memory 260 may receive the accumulated stress data ASD from the accumulated resolution converter 250. The first accumulated volatile memory 260 may store the accumulated stress data ASD.

The accumulated nonvolatile memory 640 may receive the accumulated stress data ASD from the first accumulated volatile memory 260. The accumulated nonvolatile memory 640 may store the accumulated stress data ASD.

The second accumulated volatile memory 270 may receive the accumulated stress data ASD from the accumulated nonvolatile memory 640. The second accumulated volatile memory 270 may store the accumulated stress data ASD.

The intermediate compensation data generator 280 may receive the accumulated stress data ASD from the second accumulated volatile memory 270. The intermediate compensation data generator 280 may generate intermediate compensation data ICD corresponding to the accumulated stress data ASD based on the accumulated stress data ASD. Therefore, a resolution of the intermediate compensation data ICD may be equal to or substantially equal to the resolution of the accumulated stress data ASD. In this case, the resolution of the intermediate compensation data ICD may be the reference resolution, the resolution of the intermediate compensation data ICD may be equal to or substantially equal to the resolution of the accumulated stress data ASD, and the resolution of the intermediate compensation data ICD may be P×Q.

The compensation resolution converter 290 may receive the intermediate compensation data ICD from the intermediate compensation data generator 280. In addition, the compensation resolution converter 290 may receive the input image data IMG. The compensation resolution converter 290 may change the resolution of the intermediate compensation data ICD to the input resolution. Therefore, the resolution of the changed intermediate compensation data ICD may be M×N.

The compensation nonvolatile memory 620 may receive the changed intermediate compensation data ICD from the compensation resolution converter 290. The compensation nonvolatile memory 620 may update the compensation data CD corresponding to the input resolution from among the first to K-th compensation data with the changed intermediate compensation data ICD.

The input image data IMG, the first to K-th compensation data, the data signal DATA, the intermediate accumulated stress data IASD, the accumulated stress data ASD, and a resolution of the intermediate compensation data ICD may correspond to a position of a pixel PX.

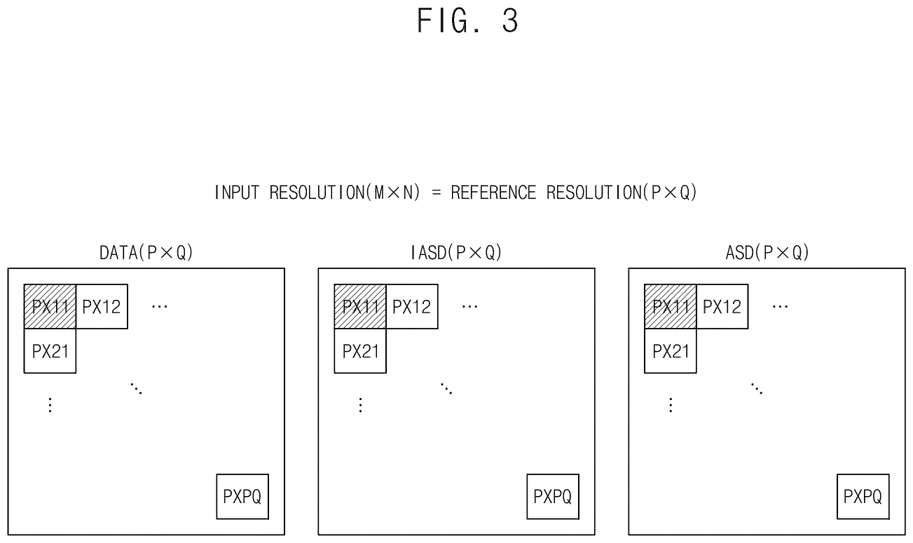

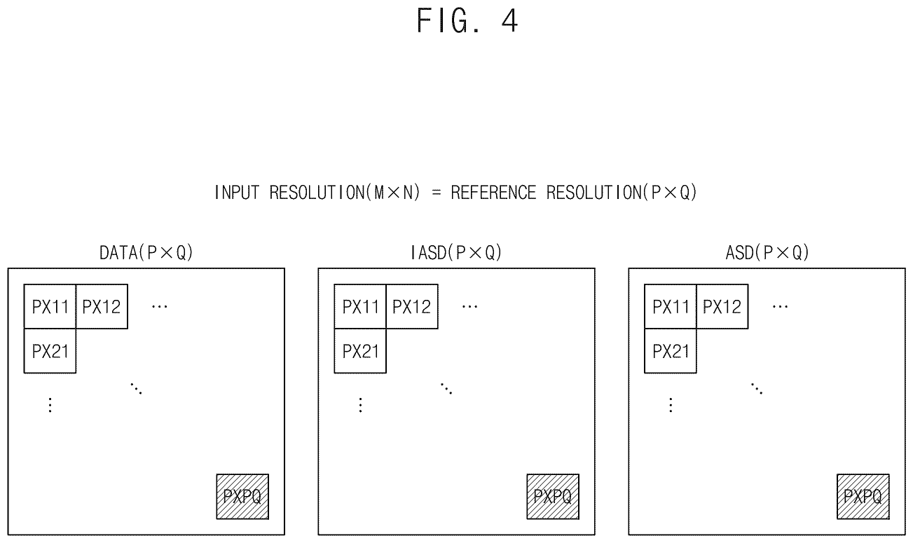

FIGS. 3 and 4 are diagrams showing an example of an operation when the input resolution is equal to the reference resolution.

FIGS. 3 and 4 illustrate a case where the input resolution M×N is equal to or substantially equal to the reference resolution P×Q. For example, the input resolution and the reference resolution may be 3840×2160 (UHD).

As shown in FIG. 3, input image data IMG of a 1×1 pixel PX11 may correspond to a data signal DATA of the 1×1 pixel PX11. The 1×1 pixel PX11 may correspond to the data signal DATA of the 1×1 pixel PX11, and the 1×1 pixel PX11 may deteriorate based on the input image data IMG of the 1×1 pixel PX11.

Intermediate accumulated stress data IASD of the 1×1 pixel PX11 may correspond to the input image data IMG of the 1×1 pixel PX11. Therefore, the intermediate accumulated stress data IASD of the 1×1 pixel PX11 may correspond to the data signal DATA of the 1×1 pixel PX11. Accordingly, the intermediate accumulated stress data IASD of the 1×1 pixel PX11 may accurately reflect the deterioration degree of the 1×1 pixel PX11.

The intermediate accumulated stress data IASD of the 1×1 pixel PX11 may correspond to the accumulated stress data ASD of the 1×1 pixel PX11. Therefore, the accumulated stress data ASD of the 1×1 pixel PX11 may correspond to the data signal DATA of the 1×1 pixel PX11. Accordingly, the accumulated stress data ASD of the 1×1 pixel PX11 may accurately reflect the deterioration degree of the 1×1 pixel PX11.

As such, when the input resolution is equal to or substantially equal to the reference resolution, the intermediate accumulated stress data IASD and the accumulated stress data ASD may accurately reflect the deterioration degree of the 1×1 pixel PX11.

As shown in FIG. 4, input image data IMG of a P×Q pixel PXPQ may correspond to a data signal DATA of the P×Q pixel PXPQ, and the P×Q pixel PXPQ may deteriorate based on the input image data IMG of the P×Q pixel PXPQ.

Intermediate accumulated stress data IASD of the P×Q pixel PXPQ may correspond to the input image data IMG of the P×Q pixel PXPQ. Therefore, the intermediate accumulated stress data IASD of the P×Q pixel PXPQ may correspond to the data signal DATA of the P×Q pixel PXPQ. Accordingly, the intermediate accumulated stress data IASD of the P×Q pixel PXPQ may accurately reflect a deterioration degree of the P×Q pixel PXPQ.

The intermediate accumulated stress data IASD of the P×Q pixel PXPQ may correspond to the accumulated stress data ASD of the P×Q pixel PXPQ. Therefore, the accumulated stress data ASD of the P×Q pixel PXPQ may correspond to the data signal DATA of the P×Q pixel PXPQ. Accordingly, the accumulated stress data ASD of the P×Q pixel PXPQ may accurately reflect the deterioration degree of the P×Q pixel PXPQ.

As such, when the input resolution is equal to the reference resolution, the intermediate accumulated stress data IASD and the accumulated stress data ASD may accurately reflect the deterioration degree of the P×Q pixel PXPQ.

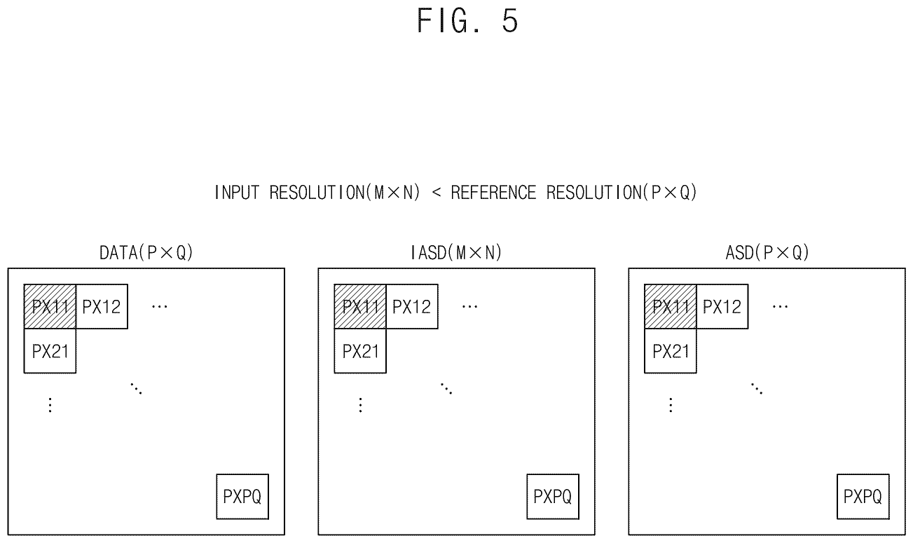

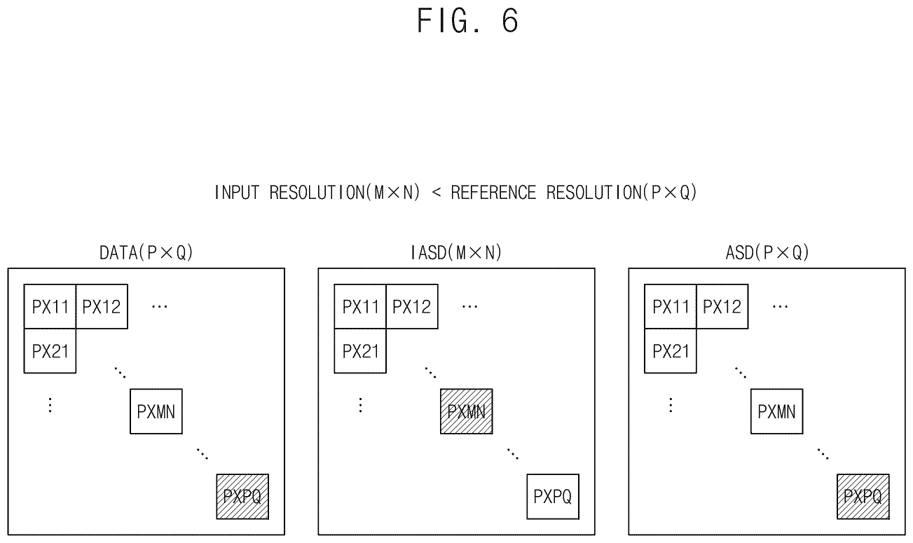

FIGS. 5 and 6 are diagrams showing an example of an operation when the input resolution is different from the reference resolution.

FIGS. 5 and 6 illustrate a case where the input resolution M×N is different from the reference resolution P×Q. In an embodiment, the input resolution may be smaller than the reference resolution. In another embodiment, the input resolution may be greater than the reference resolution. For example, the input resolution may be 1920×1080 (FHD; Full High Definition), and the reference resolution may be 3840×2160 (UHD; Ultra High Definition). In other words, the input resolution may be ¼ of the reference resolution.

As shown in FIG. 5, input image data IMG of the 1×1 pixel PX11 may correspond to a data signal DATA of the 1×1 pixel PX11, and the 1×1 pixel PX11 may deteriorate based on the input image data IMG of the 1×1 pixel PX11.

Intermediate accumulated stress data IASD of the 1×1 pixel PX11 may correspond to the input image data IMG of the 1×1 pixel PX11. Therefore, the intermediate accumulated stress data IASD of the 1×1 pixel PX11 may correspond to the data signal DATA of the 1×1 pixel PX11. Accordingly, the intermediate accumulated stress data IASD of the 1×1 pixel PX11 may accurately reflect a deterioration degree of the 1×1 pixel PX11.

The intermediate accumulated stress data IASD of the 1×1 pixel PX11 may correspond to the accumulated stress data IASD of the 1×1 pixel PX11. Therefore, the accumulated stress data ASD of the 1×1 pixel PX11 may correspond to the data signal DATA of the 1×1 pixel PX11. Accordingly, the accumulated stress data ASD of the 1×1 pixel PX11 may accurately reflect the deterioration degree of the 1×1 pixel PX11.

As such, even if the input resolution is different from the reference resolution, the intermediate accumulated stress data IASD and the accumulated stress data ASD may accurately reflect the deterioration degree of the 1×1 pixel PX11.

As shown in FIG. 6, input image data IMG of M×N pixels PXMN may correspond to a data signal DATA of the P×Q pixels PXPQ, and the P×Q pixels PXPQ may deteriorate based on the input image data IMG of the M×N pixels PXMN.

Intermediate accumulated stress data IASD of the M×N pixels PXMN may correspond to the input image data IMG of the M×N pixels PXMN. Therefore, the intermediate accumulated stress data IASD of the M×N pixels PXMN may correspond to the data signal DATA of the P×Q pixels PXPQ. In this case, even though the P×Q pixel PXPQ deteriorates, the intermediate accumulated stress data IASD of the M×N pixel PXMN may include incorrect information that the M×N pixel PXMN deteriorates, and the intermediate accumulated stress data IASD of the M×N pixels PXMN may not accurately reflect a deterioration degree of the P×Q pixels PXPQ.

In comparison, in some embodiments the resolution of the intermediate accumulated stress data IASD may be changed to the reference resolution to generate the accumulated stress data ASD.

In this case, the intermediate accumulated stress data IASD of the M×N pixels PXMN may correspond to the accumulated stress data IASD of the P×Q pixels PXPQ. Therefore, the accumulated stress data ASD of the P×Q pixel PXPQ may correspond to the data signal DATA of the P×Q pixel PXPQ. In this case, when the P×Q pixel PXPQ deteriorates, the accumulated stress data ASD of the P×Q pixel PXPQ may include correct information that the P×Q pixel PXPQ deteriorates, and the accumulated stress data ASD of the P×Q pixel PXPQ may accurately reflect the deterioration degree of the P×Q pixel PXPQ.

As such, when the input resolution is different from the reference resolution, the intermediate accumulated stress data IASD may not accurately reflect the degradation degree of the P×Q pixels PXPQ, but the accumulated stress data ASD may accurately reflect the deterioration degree of the P×Q pixel PXPQ.

As described above, when the input resolution is different from the reference resolution, the compensator 230 may generate the data signal DATA based on the reference resolution regardless of the input resolution, and the display panel 100 may deteriorate based on the resolution of the data signal DATA. However, because the accumulator 240 accumulates the input image data IMG to generate the intermediate accumulated stress data IASD, the intermediate accumulated stress data IASD may not accurately reflect the deterioration degree of the pixels PX. In more detail, the intermediate accumulated stress data IASD may not accurately reflect the deterioration degree of the pixels PX (e.g., the P×Q pixel PXPQ) corresponding to a difference between the input resolution and the reference resolution. Therefore, the display device 10 may include the accumulated resolution converter 250, such that the accumulated resolution converter 250 may change the resolution of the intermediate accumulated stress data IASD to the reference resolution, and generate the accumulated stress data ASD to more accurately reflect the deterioration degree of the pixels PX. In addition, the display device 10 may include the intermediate compensation data generator 280 and the compensation resolution converter 290, such that the intermediate compensation data generator 280 may generate the intermediate compensation data P×Q corresponding to the accumulated stress data ASD based on the accumulated stress data ASD, and change the resolution of the accumulated stress data ASD to the input resolution to update the compensation data CD corresponding to the input resolution from among the first to K-th compensation data.

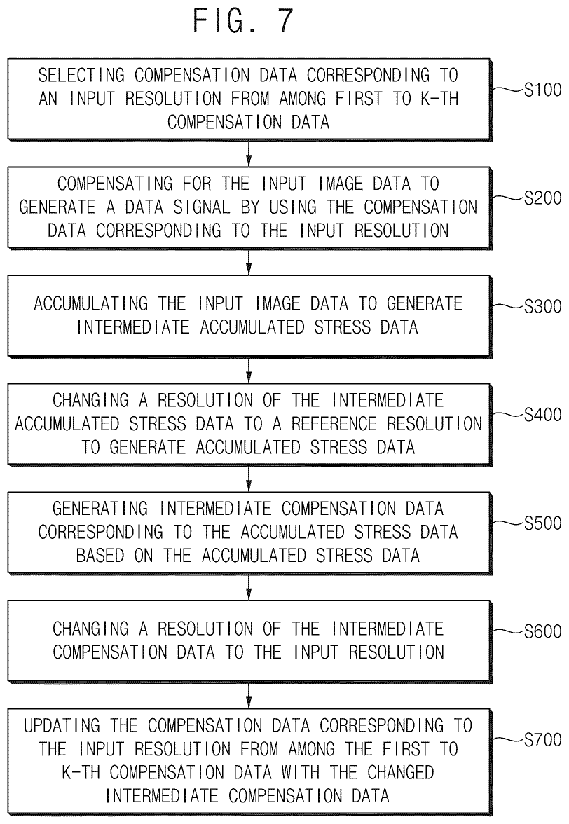

FIG. 7 is a flowchart illustrating a method of compensating for an image sticking in a display device 10 according to one or more embodiments of the present disclosure.

A method of compensating for the image sticking in the display device 10 according to some embodiments of the present disclosure may be the same or substantially the same as that described for the display device 10 described in more detail above with reference to FIGS. 1 to 6. Therefore, in FIG. 7, the same reference numbers may be used to denote the same or substantially the same (or similar) components as those described above, and redundant description may not be repeated.

Referring to FIGS. 1 to 7, the method of compensating for the image sticking in the display device 10 according to some embodiments of the present disclosure may include selecting compensation data CD corresponding to an input resolution, which is a resolution of the input image data IMG, from among first to K-th compensation data having different resolutions from each other (where K is a positive integer of 2 or more) (block S100), compensating for the input image data IMG to generate a data signal DATA by using the compensation data CD corresponding to the input resolution (block S200), accumulating the input image data IMG to generate intermediate accumulated stress data IASD (block S300), and changing a resolution of the intermediate accumulated stress data IASD to a reference resolution to generate accumulated stress data ASD (block S400).

In an embodiment, the method may further include generating intermediate compensation data ICD corresponding to the accumulated stress data ASD based on the accumulated stress data ASD (block S500).

In an embodiment, the method may further include changing a resolution of the intermediate compensation data ICD to the input resolution (block S600).

In an embodiment, the method may further include updating the compensation data CD corresponding to the input resolution from among the first to K-th compensation data with the changed intermediate compensation data (block S700).

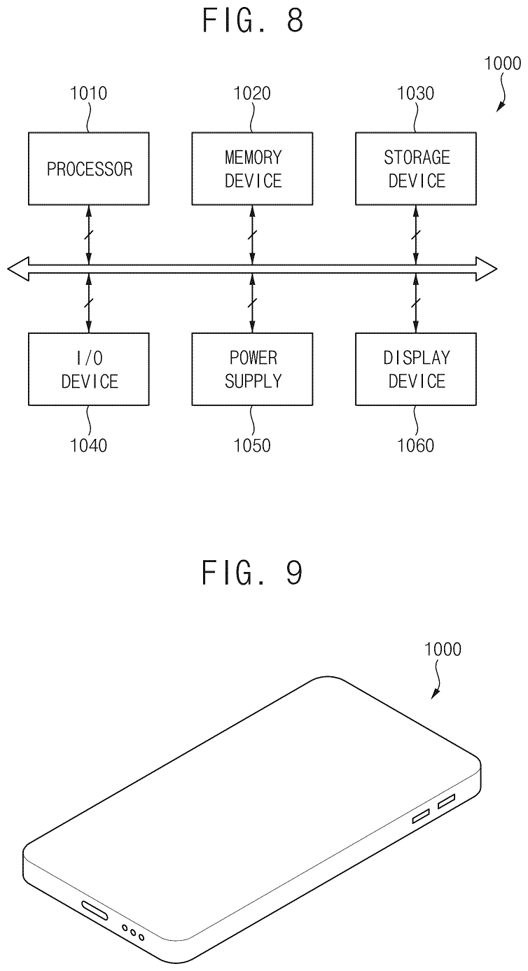

FIG. 8 is a block diagram illustrating an electronic device 1000. FIG. 9 is a diagram illustrating the electronic device 1000 of FIG. 8 in an embodiment implemented as a smart phone.

Referring to FIGS. 8 and 9, the electronic device 1000 may include a processor 1010, a memory device 1020, a storage device 1030, an input/output (I/O) device 1040, a power supply 1050, and a display device 1060. The display device 1060 may be the display device 10 described above with reference to FIG. 1. In addition, the electronic device 1000 may further include a plurality of ports for communicating with a video card, a sound card, a memory card, a universal serial bus (USB) device, other electronic devices, and/or the like.

In an embodiment, as illustrated in FIG. 9, the electronic device 1000 may be implemented as a smart phone. However, the present disclosure is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and/or the like.

The processor 1010 may perform various computing functions. The processor 1010 may be a micro processor, a central processing unit (CPU), an application processor (AP), and/or the like. The processor 1010 may be coupled to other components via an address bus, a control bus, a data bus, and the like. Further, the processor 1010 may be coupled to an extended bus, such as a peripheral component interconnection (PCI) bus.

The memory device 1020 may store data for the operations of the electronic device 1000. For example, the memory device 1020 may include at least one nonvolatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and/or the like, and/or at least one volatile memory device, such as a dynamic random access memory (DRAM) device, a static random access memory (SRAM) device, a mobile DRAM device, and/or the like.

The storage device 1030 may include a solid state drive (SSD) device, a hard disk drive (HDD) device, a CD-ROM device, and/or the like.

The I/O device 1040 may include an input device, such as a keyboard, a keypad, a mouse device, a touch-pad, a touch-screen, and/or the like, and an output device, such as a printer, a speaker, and/or the like. In some embodiments, the I/O device 1040 may include the display device 1060.

The power supply 1050 may provide power for the operations of the electronic device 1000.

The display device 1060 may be connected to other components through buses or other suitable communication links.

Some embodiments of the present disclosure described above may be applied to any suitable display device and any suitable electronic device including a touch panel. For example, some embodiments of the present disclosure described above may be applied to a mobile phone, a smart phone, a tablet computer, a digital television (TV), a 3D TV, a personal computer (PC), a home appliance, a laptop computer, a personal digital assistant (PDA), a portable multimedia player (PMP), a digital camera, a music player, a portable game console, a navigation device, and/or the like.

The electronic or electric devices and/or any other relevant devices or components according to embodiments of the present disclosure described herein (e.g., the compensation data selector, the compensator, the accumulator, the accumulated resolution converter, the intermediate compensation data generator, the compensation resolution converter, and/or the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A display device, comprising:
a display panel; and
a display panel driver configured to generate a data signal based on input image data, and generate a data voltage based on the data signal to provide the data voltage to the display panel,
wherein the display panel driver is further configured to:
select compensation data from among first to K-th compensation data having different resolutions from each other, where K is a positive integer of 2 or more, the compensation data corresponding to an input resolution of the input image data;
compensate for the input image data to generate the data signal by using the compensation data corresponding to the input resolution;
accumulate the input image data to generate intermediate accumulated stress data; and
change a resolution of the intermediate accumulated stress data to a reference resolution to generate accumulated stress data.

2. The display device of claim 1, wherein the reference resolution is equal to a resolution of the display panel.

3. The display device of claim 1, wherein a resolution of the data signal is equal to the reference resolution.

4. The display device of claim 3, wherein the resolution of the intermediate accumulated stress data is equal to the input resolution.

5. The display device of claim 4, wherein a resolution of the accumulated stress data is equal to the reference resolution.

6. The display device of claim 5, wherein, when the input resolution is changed, the resolution of the data signal and the resolution of the accumulated stress data are constant at the reference resolution, and the resolution of the intermediate accumulated stress data is changed depending on the input resolution.

7. The display device of claim 1, wherein the display panel driver comprises:
a nonvolatile memory configured to store the accumulated stress data and the first to K-th compensation data;
a compensation data selector configured to select the compensation data corresponding to the input resolution from among the first to K-th compensation data;
a compensator configured to compensate for the input image data to generate the data signal by using the compensation data corresponding to the input resolution;
an accumulator configured to accumulate the input image data to generate the intermediate accumulated stress data; and
an accumulated resolution converter configured to change the resolution of the intermediate accumulated stress data to the reference resolution to generate the accumulated stress data.

8. The display device of claim 7, wherein the display panel driver further comprises a compensation volatile memory configured to store the compensation data corresponding to the input resolution selected by the compensation data selector.

9. The display device of claim 8, wherein the display panel driver further comprises:
a first accumulated volatile memory configured to store the accumulated stress data generated by the accumulated resolution converter; and
a second accumulated volatile memory configured to store the accumulated stress data provided from the nonvolatile memory.

10. The display device of claim 7, wherein the display panel driver further comprises an intermediate compensation data generator configured to generate intermediate compensation data corresponding to the accumulated stress data based on the accumulated stress data stored in the nonvolatile memory.

11. The display device of claim 10, wherein the display panel driver further comprises a compensation resolution converter configured to change the resolution of the intermediate compensation data to the input resolution.

12. The display device of claim 11, wherein the compensation data corresponding to the input resolution from among the first to K-th compensation data is updated based on the change of the resolution of the intermediate compensation data.

13. A method of compensating for an image sticking in a display device, the method comprising:
selecting compensation data from among first to K-th compensation data having different resolutions from each other, where K is a positive integer of 2 or more, the compensation data corresponding to an input resolution of input image data;
compensating for the input image data to generate a data signal by using the compensation data corresponding to the input resolution;
accumulating the input image data to generate intermediate accumulated stress data; and
changing a resolution of the intermediate accumulated stress data to a reference resolution to generate accumulated stress data.

14. The method of claim 13, wherein the reference resolution is equal to a resolution of a display panel.

15. The method of claim 13, wherein a resolution of the data signal is equal to the reference resolution.

16. The method of claim 15, wherein the resolution of the intermediate accumulated stress data is equal to the input resolution.

17. The method of claim 16, wherein a resolution of the accumulated stress data is equal to the reference resolution.

18. The method of claim 17, wherein, when the input resolution is changed, the resolution of the data signal and the resolution of the accumulated stress data are constant at the reference resolution, and the resolution of the intermediate accumulated stress data is changed depending on the input resolution.

19. The method of claim 13, further comprising:
generating intermediate compensation data corresponding to the accumulated stress data based on the accumulated stress data.

20. The method of claim 19, further comprising:
changing a resolution of the intermediate compensation data to the input resolution.

21. The method of claim 20, further comprising:
updating the compensation data corresponding to the input resolution from among the first to K-th compensation data based on the changing of the resolution of the intermediate compensation data.

22. An electronic device, comprising:
a display panel;
a display panel driver configured to generate a data signal based on input image data, and generate a data voltage based on the data signal to provide the data voltage to the display panel; and
a processor configured to control the display panel driver,
wherein the display panel driver is further configured to:
select compensation data from among first to K-th compensation data having different resolutions from each other, where K is a positive integer of 2 or more, the compensation data corresponding to an input resolution of the input image data;
compensate for the input image data to generate the data signal by using the compensation data corresponding to the input resolution;
accumulate the input image data to generate intermediate accumulated stress data; and
change a resolution of the intermediate accumulated stress data to a reference resolution to generate accumulated stress data.
